(19) United States
(12) Patent Application Publication
(10) Pub. No.: US 2005/0180428 A1
(43) Pub. Date: Aug. 18, 2005

(54) Cross media information integration system

(75) Inventors: Fu-Sheng Chiu, Taipei (TW); Chi-Yu Lai, Taipei (TW)

Correspondence Address: BACON & THOMAS, PLLC, 625 SLATERS LANE, FOURTH FLOOR, ALEXANDRIA, VA, 22314, US

(73) Assignee: ERA DIGITAL MEDIA CO., LTD., Taipei (TW)

(21) Appl. No.: 10/963,500

(22) Filed: Oct. 14, 2004

(30) Foreign Application Priority Data
Feb. 13, 2004 (TW) 093103480

(51) Int. Cl. H04L 12/56

(52) U.S. Cl. 370/395.5; 370/466

(57) ABSTRACT

The present invention is to provide a cross media information integration system comprising at least one computer, at least one handset and at least one media platform, such as a television and a cross media center, built individually on an end of Internet, telecommunication network and mass media network, so that different types of information among the computer, handset, and television can be sent or received between Internet, telecommunication network or digital mass media network through the cross media center, enabling different kinds of data/information from the media platforms of different types among these networks to be integrated and outputted to each media platform to achieve the data synchronization and the instant and interactive purposes.

### FIELD OF THE INVENTION

The present invention relates to a cross media information integration system, more particularly to a system that utilizes a cross media center in between Internet, telecommunication network and mass media network for exchanging different kinds of data/information and enabling the data/information among these networks to be integrated and outputted to media platforms of different types.

### BACKGROUND OF THE INVENTION

Since the industrial technology is blooming, therefore new tools are introduced unceasingly into companies for performing the research and development and production or manufacturing products, and thus the functions provided by various tools make our life more convenient. For example, the invention of telecommunication systems such as radio transmitters, telegram machines, telephones and mobile phones, etc. greatly enhances and changes the original correspondence or communication method of writing letters.

Further, the transmission of information no longer depends on oral communication between people or plane media (such as a newspaper or a magazine) after the invention of a broadcasting station and a television, etc; particularly the mass media of the broadcasting station and television have the features of delivering instant information and having a broad area coverage and audio/video effects, and also being capable of delivering information through various hardware such as the life television vehicle, so that people at thousands of miles away can timely hear or see the scene of the commentary and no longer need to wait for a long time or imagine the situation of the event out of thin air anymore. Thus, plane media such as newspapers and magazines having a poor promptness gradually die down.

Further, the electronic industry is blooming in recent years, so that various products are developed in the electronic direction and there is a so-called “Digital Era”. An important invention in the digital era is Internet which overthrows the one-way broadcasting method of the mass media in the past and features fast speed, parallelism, bidirectional interaction, cross areas and cross system integration. Internet has become the world's largest broadcasting network, so that the original mass media systems including the broadcasting station and television are putting in their efforts in digitization to develop products such as a network broadcasting station, a set-top-box or a digital television, etc, so that the traditional mass media systems can be connected to Internet by the method of using digital contents to constitute a digital mass media system, and providing a better transmission rate and quality to new hardware for two-way communications. With the development of the digitized and wireless communication technology, an analog telecommunication network primarily based on voices becomes a digital telecommunication network with better transmission rate and quality. For example, mobile phones originally converts analog signals into digital signals, and the digital signal is developed progressively from 2 G, 2.5 G, and 3 G to NGS, and the scope of its application is expanded from the original fixed voice communications to data transmission that covers almost everything, such as the short message service (SMS) for transmitting text information or Multimedia Messaging Service (MMS) for transmitting text, graphics, ring tones, images, voices, and the content of the aforementioned information shows the dynamic feeling with sound and light instead of simple short writing. Such arrangement overthrows all traditional voice communication methods, so mobile phones have become the most popular and convenient portal device. Speed and bidirectional communications are still the major features of such digital telecommunication network.

In summation of the description above, the common features for three kinds of systems: “Digital Mass Media System”, “Digital Telecommunication Network” and “Internet” reside on providing a faster transmission, more transmitted contents and better quality. According to the present situations of practical applications, Internet and telecommunication network have developed several kinds of communication applications; for examples, the foregoing handset is used to send short messages, and these short messages can be posted onto an Internet server through an application program of the handset and telecommunication network to become a discussion forum for users to leave their messages. Alternatively, the contents of the short messages are sent directly to other handsets through the application programs of browsers, servers and handsets. Data transmissions of this sort are common between “Digital Telecommunication Network” and “Internet”. However, the telecommunication network and Internet are used as a tool or a service provider all the time, such as using the short messages in the telecommunication network for doing surveys, the IVR function for voting, the Internet for voting, or the Internet as a discussion forum for discussing and posting ideas. From the viewpoint of digital mass media system, the applications of these sorts are simply applications of collecting information and source materials, and do not allow any exchange of information and interactions among the three networks. In other words, such arrangement cannot really achieve the objective of exchanging information instantly.

### SUMMARY OF THE INVENTION

In view of the shortcomings of the prior art, the inventor of the present invention conducted extensive researches and experiments, and finally developed and invented a cross media information integration system. The cross media information integration system in accordance with the invention comprises at least one computer, at least one handset and at least one media platform such as a television and a cross media center; wherein the media platform is built individually on the end of Internet, telecommunication network and mass media network, so that different information among the computer, handset, and television can be sent or received through Internet, telecommunication network or digital mass media network, and the cross media center is connected to these networks. If any of the source media platforms (such as a computer) is going to send data/information to a target media platform of a different type, the source media platform will use its corresponding network to send the data/information to the cross media center first, so that different kinds of data/information from the media platforms of different types among these networks are integrated and outputted to each media platform to achieve the data synchronization and the instant and interactive purposes.

The above and other objects, features and advantages of the present invention will become apparent from the following detailed description taken with the accompanying drawing.

### BRIEF DESCRIPTION OF THE DRAWINGS

FIG. 1 is an illustrative view of the structure of the present invention.

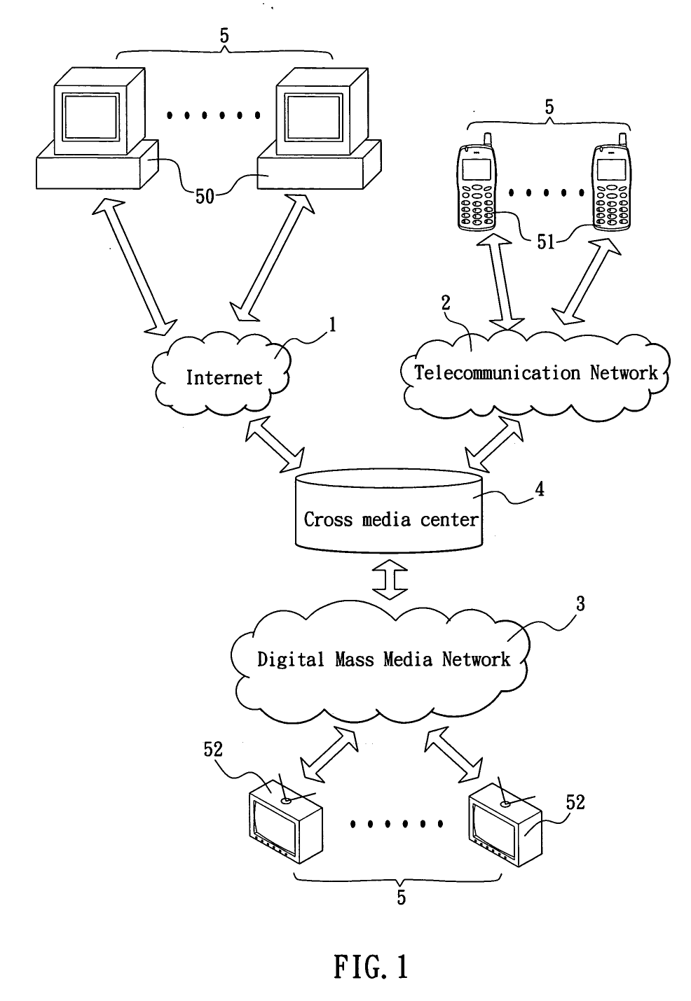

### DETAILED DESCRIPTION OF THE PREFERRED EMBODIMENTS

The present invention discloses a cross media information integration system which comprises a cross media center 4 (CMC) among an Internet 1, a telecommunication network 2 and a digital mass media network 3, and the Internet 1, the telecommunication network 2 and the mass media network 3 are individually connected to at least one media platform 5 selected from a computer 50, a handset 51 or a television 52, such that all kinds of data/information among the computer 50, handset 51 and television 52 can be transmitted and received through the Internet 1, telecommunication network 2 or digital mass media network 3. If one of the source media platform 5 (such as the computer) is going to send data/information to a target media platform 5 of a different type, then the source media platform 5 uses its corresponding network to send the data/information to the cross media center 4 first, and the target media platform 5 obtains the required data/information from the cross media center 4, and further allows all media platforms such as the computer 50, handset 51 and television 52 among those networks to obtain the required data/information from the cross media center 4 and integrate the data/information, such that each media platform 5 shows the same outputted result (such as the same screen) in order to achieve the purpose of having synchronous, instant and interactive information.

In the present invention, the media platform 5 including the handset 51, television 51 and computer 50 individually has an application program interface, so that the media platforms 5 can use the application program interface to convert the data coming from each media platform 5 into a specific transmission format, and then the corresponding networks of the media platforms 5 send the data to the media cross center 4 for storage. Therefore, the media platforms 5 can obtain the required data/information from the cross media center 4 and integrate and display the data/information on the same media platform 5 easily.

The various services provided by current handsets such as the data/information of the short message, MMS and streaming media are transmitted between the telecommunication network and the handset or the data/information such as the short message, MMS and streaming media sent from the computer is sent from the Internet to the server of the telecommunication network service provider by using a computer through the Internet server, so that the server of the telecommunication network service provider can send the data/information to the telecommunication switchboard of the telecommunication network, and further from the telecommunication to the handset or read the data/information (such as email or instant communication) in the Internet server by the handset through the telecommunication network and Internet. The digital mass media network also adopts the same technique to display the data/information on a computer or a television. However, the signals can only be sent two-way among the computer, handset and television; that is, a mutual transmission between the computer and the handset or between the computer and the television. Such arrangement is unable to achieve a three-way communication, but the present invention can solve this problem. To make it easier for our examiner to understand the objective of the invention, its structure, innovative features, and performance, we use a preferred embodiment together with the attached drawings for the detailed description of the invention.

When a handset 51 sends its data/information to a telecommunication network 2, the telecommunication network 2 uses an application programming interface to convert the data/information into a specific transmission format, and the data in such specific format is sent to the cross media center 4 for the storage, such that the computer 50 and the television 52 obtain the data/information in the specific transmission format in the cross media center 4 from each Internet 1 and digital mass media network 3.

The structure for the Internet applications is the same as that for the telecommunication network 2. If the computer 50 sends the data including text, pictures, emails, and streaming media created by different application programs to the database in the network server via Internet 1, the network server also sends the data/information in the specific transmission format to the cross media center 4 for storage at the same time by a specific application programming interface, so that the handset 51 and the television 52 obtain the data/information in the specific transmission format in the cross media center 4 from each telecommunication network 2 and digital mass media network 3.

Besides obtaining data from the cross media center 4 by the application programming interface, mostly important, the application of a digital mass media network 3 can attain the function of integrating data with the mass media.

After the digital mass media network 3 has obtained the required data from the cross media center 4 through the application programming interface, the data is saved into a media database first, and the media database maintains the content of the cross media center 4 when the data of the digital media network 3 is changed. The content required by the media platform 5 obtains the data/information in a specific transmission format automatically, semi-automatically or manually through a real time editing platform for editing. Then, the edited data is sent to related staffs such as a director in the secondary control room for producing the contents of digital programs and merging the data contents, so that the contents of the television programs of the digital mass media network 3 can be shown on a computer 50 or a handset 51 or sent to the cross media center 4 through the application programming interface and further to the computer 50 or the handset 51 through the Internet 1 or the telecommunication network 2.

While the invention has been described by means of specific embodiments, numerous modifications and variations could be made thereto by those skilled in the art without departing from the scope and spirit of the invention set forth in the claims.

1. A cross media information integration system, comprising at least one computer, at least one handset, at least one television media platform and a cross media center, and said media platform and cross media center being constructed among the Internet, a telecommunication network and a digital mass media network, such that said media platform sends data through said networks and when one of said media platforms media platform sends data/information out, the data transmission comprises the steps of:
sending the data/information of a source media platform from its corresponding network to said cross media center; and
using a target media platform to obtain required data/information from said cross media center, such that said target media platform successfully receives said data/information for a further processing.

2. The cross media information integration system of claim 1, wherein said handset, television and computer media platforms individually comprising an application programming interface, so that said media platforms use said application programming interface to convert each data/information from each of said media platforms into a predetermined transmission format, and then the corresponding networks of said media platforms send said data/information to said cross media center for storage, and said media platforms obtain said data/information from said cross media center and integrate and display said data/information on a same media platform.

3. The cross media information integration system of claim 2, wherein said telecommunication network converts a data/information transmitted from said handset to said telecommunication network into a predetermined transmission format by said application programming interface, and said data/information in said transmission format is sent to said cross media center for storage, such that said computer and television obtains said data/information in said transmission format in the cross media center from each respective Internet and digital mass media network.

4. The cross media information integration system of claim 2, wherein said network server sends said data/information in said transmission format to said cross media center for storage through a specific application programming interface at the same time when said computer sends a data/information produced by different application programs through Internet to a database in said network server, thereby said handset and television obtains said data/information in said specific transmission format in said cross media center from each respective telecommunication network and digital mass media network.

5. The cross media information integration system of claim 2, wherein said digital mass media network obtains said required data from said cross media center through said application programming interface and then saves said data/information in said media database first, so that said media database maintains the contents of said cross media center when said digital mass media network changes its data.

6. The cross media information integration system of claim 5, wherein said data transmission further comprises the steps of obtaining said data/information in said specific transmission format and required by said media platform for editing by a method selected an automatic, a semi-automatic and manual methods, and merging the contents of said data/information so that the television program of said mass media network displays the information that said television program comes selectively from said computer and handset.

7. The cross media information integration system of claim 6, wherein said real time editing platform edits said data/information, and then sends said data/information to said cross media center through said application programming interface and then selectively to said computer and handset for further processing selectively through said telecommunication network and Internet.
